(19) United States
(12) Patent Application Publication
(10) Pub. No.: US 2006/0196238 A1
(43) Pub. Date: Sep. 7, 2006

(54) Door locking system

(76) Inventor: Ben-Zion Avni, Kfar Saba (IL)

Correspondence Address: NATH & ASSOCIATES, 112 South West Street, Alexandria, VA, 22314, US

(21) Appl. No.: 10/543,599

(22) PCT Filed: Feb. 1, 2004
(86) PCT No.: PCT/IL04/00095

§ 371 Date: Jul. 27, 2005

(30) Foreign Application Priority Data
Jan. 30, 2003 (IL) 154193

(51) Int. Cl. E05B 13/00

(52) U.S. Cl. 70/218

(57) ABSTRACT

A locking system for building door includes a lock latch engaged with a door handle through an engagement mechanism comprising inner, intermediate and outer base members coaxially rotatable relative to each other. The inner member is connected with the handle. The intermediate member is connected with the latch and provided with a radially movable engagement member. In the door locking state, the engagement member enters a notch in the inner member and contacts with an underspringed pusher, which is movably located in the outer base member allowing expelling the engagement member from the notch and free rotating the inner member. In the door unlocking state, a blocking bar controlled by user prevents the engagement member from expelling out of the notch, thereby engaging the inner and intermediate members and providing their joint rotation by handle.

### BACKGROUND OF THE INVENTION

1. Field of the Invention

The present invention relates to the lock systems of the doors, specifically, designed for the external safety doors of the apartments or buildings.

2. Description of the Prior Art

The known door locking systems include the mechanism for the control of engaging the door handle and the door lock latch In the door locked state, the door handle and the lock latch are disengaged and, therefore, the door can not be unlocked with the door handle. To unlock the door, user engages the door handle and the lock latch by means of an engagement mechanism and unlocks the door by the door handle. As a rule, the engagement mechanism is actuated by the detail movement directed perpendicular to the door plane and designed to pull the members of the door handle and the lock latch together or to introduce an engagement member between the members of the door handle and the lock latch. The disadvantage of this engagement mechanism is its complexity caused with the necessity of transposing the relatively large details or assembles and returning them to their original positions. Introducing the mentioned members into engagement demands applying of substantial force and is connected with the detail wear and the possibility of member jamming. As a result, the durability and reliability of the door lock system is decreased. Besides, providing the detail drive in the direction perpendicular to the door plane is awkward as the door size in this direction is limited.

Patent EP1152106 can be considered as an example of the existing engagement mechanisms. The mechanism includes a grip collar with a lower necked section rotatably mounted in the door plate and a bush rotatably mounted on the mentioned necked section and having a locking ball assembly. There is also a poligonal actuating bar for introducing into the central bore in the necked section in the direction perpendicular to the door plane in order to displace four balls to the notches in the necked section and thereby to engage the necked section and the bush. The above noted disadvantages, such as the design complexity, decreased reliability and durability and the other fully relate to this patent because it comprises the polygonal actuating bar to be transposed in the direction perpendicular to the door plane. Furthermore, central disposition of the actuating bar in this design creates the problems for the central disposition of the rotatable door handle, as well as for the control of the door locking system by two means, for instance by a constantly used electrical drive and an alternate mechanical drive.

### SUMMARY OF THE INVENTION

The objective of the present invention is the simplification of the engagement mechanism of the door lock system and the reduction of its cost.

Another objective is heightening the durability and the reliability of the door locking system.

Another objective is providing the suitability of the door locking system for the control by two, main and alternate means.

The above noted objectives are accomplished with a door locking system including a door handle, a lock latch and a controlled engagement mechanism. The latter comprises coaxially rotatable inner and intermediate members, as well as an immovable outer base member. The inner member is connected with the door handle and slidably housed inside the intermediate member with the possibility of its rotation relative to the intermediate member. The intermediate member is connected with the lock latch and slidably housed inside the outer member with the possibility of its rotation relative to the outer base member. The engagement mechanism also comprises an engagement member movably housed in a radial through opening in the intermediate member and, in the door locked state, entering a notch of the inner member by its one side and constantly contacting with a pusher by its opposite side. The dimension of the engagement member measured in the axial direction of the radial through opening of the intermediate member is substantially equal to the sum of the wall thickness of the intermediate member and the depth of the notch of the inner member. This allows the inner and intermediate members, engaged with the engagement member, the free rotation inside the outer base member. The pusher is movably located in the outer base member, constantly forced by a spring against the engagement member in the door locked state, and provided with a blocking means for fixing the pusher in its blocking position. In this position, the pusher prevents the engagement member from the displacement beyond the limits of the intermediate and inner members thereby engaging these members and allowing the rotation of the intermediate member by the door handle. This rotation leads to displacing the lock latch and unlocking the door. The blocking means includes two lateral recesses on the pusher disposed oppositely relative to each other and two blocking bars disposed strictly against the pusher lateral recesses. One of the blocking bars is driven by a solenoid and controlled by means of a digital device and the other blocking bar has mechanical drive controlled by a door key. To unlock the door, user dials a digital code on the digital device and solenoid introduces the blocking bar into the pusher lateral recess thereby fixing the pusher in its blocking position. This allows unlocking the door by rotating the door handle. The blocking bar with mechanical drive serves as an alternate means for use if the malfunctions of the electrical drive occur.

As distinct from the prior art, the proposed engagement mechanism has three, inner, intermediate and outer base members rotatable relative to each other and only one engagement member disposed in the radial through opening of the intermediate member and partially displaced into the inner or outer base members. This enables the arrangement of the pusher and the blocking bars laterally relative to the inner and intermediate members. As a result, practically all the engagement mechanism is disposed in the door plane that simplifies the installation of the door handle and facilitates the use of the dual control of the door locking system. The use of only one engagement member also substantially simplifies the design. The engagement member practically is immovable relative to the intermediate and inner members in locked, unlocked and transitional door states, reducing to a minimum the friction, wear and jamming in the engagement mechanism. Besides, there are no any transpositions of the engagement member or the inner and intermediate members directed to the engagement of the door handle and the lock latch. Instead, there is only insignificant displacement of one blocking bar in the door plane that is substantially less than the needed transpositions in the prior art. As a result, the design of the engagement mechanism is sufficiently simple, reliable, durable and suitable for applying the double control means.

### BRIEF DESCRIPTION OF 1BE DRAWINGS

FIG. 1 shows the engagement mechanism of the door locking system in the door locked state.

FIG. 2 shows the engagement mechanism in the door locked state upon rotated the door handle.

FIG. 3 shows the engagement mechanism in the door unlocked state.

### DETAILED DESCRIPTION OF THE INVENTION

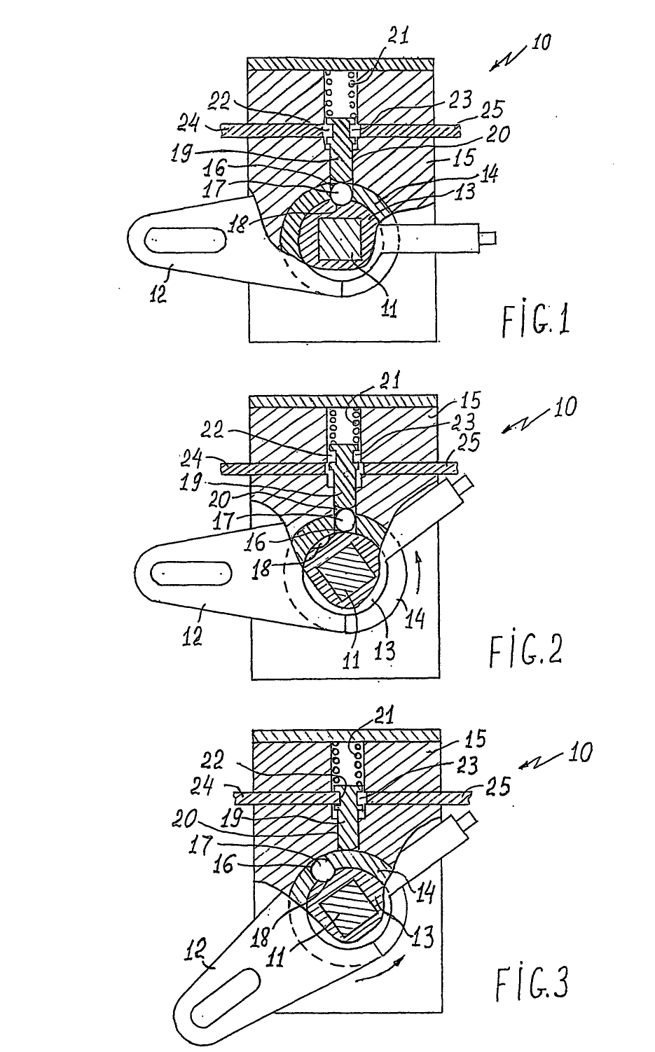

Referring first to FIG. 1, a door locking system will be described. FIG. 1 shows engagement mechanism 10 of the door locking system in the door locked state. The door locking system includes door handle 11 (shown partly), a lock latch (not shown) connected with arm 12, and engagement mechanism 10. The latter comprises inner member 13 and intermediate member 14, which are coaxially rotatable, as well as immovable outer base member 15. Inner member 13 is connected with door handle 11 and slidably housed inside intermediate member 14 with the possibility of its rotation relative to intermediate member 14. Intermediate member 14 is connected with the lock latch through arm 12 and slidably housed inside outer base member 15 with the possibility its rotation relative to outer base member 15. Intermediate member 14 has radial through opening 16, wherein engagement member 17 is movable housed. At the same time, engagement member 17 enters notch 18 of inner member 13 by its lower side and contacts with pusher 19 by its upper side. The dimension of engagement member 17 measured in the axial direction of radial through opening 16 is substantially equal to the sum of the wall thickness of intermediate member 14 and the depth of notch 18. Engagement member 17 can be made as a ball or as a short pin with rounded ends. Pusher 19 is movably located in guide 20 of outer base member 15, forced by spring 21 against engagement member 17 and provided with the blocking means. The latter includes two lateral recesses 22, 23 oppositely disposed on pusher 19 and two blocking bars 24, 25 disposed strictly against recesses 22, 23, respectively. Blocking bar 24 is driven by solenoid (not shown), which is controlled by user through a digital electronic device (not shown) by means of dialing a digital code, or, in version embodiment, by electrical switch. Blocking bar 25 has a mechanical drive (not shown) controlled by user by means of the door key. Preferably, blocking bar 24 with its electrical drive serves as a main blocking means, while blocking bar 25 with its mechanical drive is used as an alternate blocking means if the malfunctions of the electrical drive occur.

The rotation of door handle 11 and connected with it inner member 13 without blocking pusher 19 (see FIG. 2) leads to that engagement member 17 displaces out of notch 18 overcoming the resistance of spring 21. As a result, inner member 13 and intermediate member 14 are not engaged, intermediate member 14 and its arm 12 do not rotate and the door can not be unlocked. To unlock the door, user dials a digital code on the digital device, which turns on the solenoid and the latter introduces blocking bar 24 into recess 22 of pusher 19 (see FIG. 3), thereby fixing pusher 19 in its blocking position. As a result, engagement member 17 cannot be expelled from notch 18 engaging inner member 13 and intermediate member 14. This allows rotating intermediate member 14 and its arm 12 by door handle 11, displacing the lock latch and, eventually unlocking the door.

Thus, the design of engagement mechanism 10 includes three, inner, intermediate and outer base members 13, 14, 15 rotatable relative to each other, as well as only one engagement member 17 disposed between inner member 13 and outer member 15. This allows arranging pusher 19, blocking bars 24, 25 and practically engagement mechanism 10 as a whole in the door plane, thereby simplifying it and facilitating the application of the dual control of the door locking system. The use of only one engagement member 17 also substantially simplifies the engagement mechanism design. The member position, shown in FIG. 2, is used mainly for the explanation of the principle of the engagement mechanism operation. However in practice, this position is used very seldom, while the door locked position (FIG. 1) and unlocked door position as well as the transitional position (FIG. 3) are main used positions, wherein engagement member 17 is immovable relative to inner member 13 and intermediate member 14. This reduces to a minimum the friction, wear and jamming in engagement mechanism 10. Furthermore, all the detail movement directed to the engagement of the door handle and the lock latch diminishes to only insignificant displacement of locking bar 24. This also decreases the friction, wear and jamming. As a result, there are heightening the reliability and durability of the engagement mechanism and the door locking system as a whole.

1. A door locking system, including:
One) a door handle;
Two) a lock latch for locking the door, which is disengaged with said door handle in the door locked state;
Three) a controlled engagement mechanism designed for engaging said door handle and lock latch in order to unlock the door by said door handle, said controlled engagement mechanism comprising:
An inner member and an intermediate member, which are coaxially rotatable, as well as an immovable outer base member, therewith said inner member is connected with said door handle and slidably housed inside said intermediate member with the possibility its rotation relative to said intermediate member, and said intermediate member is connected with said lock latch and slidably housed inside said outer base member with the possibility of its rotation relative to said outer base member;
An engagement member movably housed in a radial through opening in said intermediate member and, in the door locked state, said engagement member enters a notch of said inner member by its one side and contacts with a pusher by its opposite side, therewith, the dimension of said engagement member measured in the axial direction of said radial through opening is substantially equal to the sum of the wall thickness of said intermediate member and the depth of said notch;
Said pusher movably located in said outer base member and forced by a spring against said engagement member in the door locked state, not preventing said engagement member from expelling from said notch upon rotating said inner member;
a blocking means for blocking said pusher in the blocking position, preventing said engagement member from expelling from said notch and thereby engaging said inner and intermediate members, that allows the rotation of said intermediate member by means of said door handle and leads to displacing said lock latch and unlocking the door;
said blocking means including at least one blocking bar, which is adapted to entering into the engagement with said pusher in its said blocking position, and a controlling means for the control of said blocking bar by user.

2. The door locking system of claim 1, wherein said engagement member is made as a ball.

3. The door locking system of claim 1, wherein said engagement member is made as a short pin with rounded ends.

4. The door locking system of claim 1, wherein said controlling means is a mechanical drive of said locking bar controlled by user by means of the door key.

5. The door locking system of claim 1, wherein said controlling means is an electrical drive of said blocking bar.

6. The door locking system of claim 5, wherein said controlling means includes an electrical switch for the control of said electrical drive by user.

7. The door locking system of claim 5, wherein said controlling means includes a digital device for the control of said electrical drive by user by dialing a digital code.

8. The door locking system of claim 5, wherein said electrical drive of blocking bar is made as a solenoid.

9. The door locking system of claim 4, wherein there are two blocking bars, one of which has said mechanical drive and the other has an electrical drive associated with the locking bar and one of these drives is designed for preferable use, while the other drive serves as an alternate safety means.

10. The door locking system of claim 7, wherein said controlling means with electrical drive and digital device is used as a main controlling means, while said controlling means with a mechanical drive controlled by the user by means of a door key serves as an alternate means for using if the malfunctions of said electrical drive occur.

11. The door locking system of claim 1, wherein said blocking means includes at least one lateral recess on said pusher, and said at least one blocking bar is disposed laterally relative to said pusher and adapted to entering said pusher lateral recess to fix said pusher in its blocking position for unlocking the door.

12. The door locking system of claim 9, wherein said blocking means includes two said pusher lateral recesses disposed oppositely and said two blocking bars are disposed laterally relative to said pusher and oppositely relative to each other strictly against said pusher lateral recesses.

13. A door locking system, including:
One) a door handle;
Two) a lock latch for locking the door, which is disengaged with said door handle in the door locked state;
Three) a controlled engagement mechanism for engaging said door handle and lock latch in order to unlocking the door by said door handle, said engagement mechanism comprising:
An inner member, an intermediate member and an outer base member, which are coaxially rotatable relative to each other;
Said inner member connected with said door handle, having a notch on its lateral surface, slidably housed inside said intermediate member and rotated relative to it;
Said intermediate member connected with said lock latch, slidably hosed between said inner member and outer base member, rotated relative to said outer base member, and having a radial through opening in its wall;
Said outer base member immovable relative to the door and having a guide channel, which is disposed radially relative to the center of the rotation of said inner and intermediate members and, in the door locked state, located coaxially with said radial through opening;
An engagement member movably hosed in said radial through opening with the possibility of partial location in said notch or said guide channel, therewith the dimension of said engagement member measured in axial direction of said radial through opening is substantially equal to the sum of the wall thickness of said intermediate member and the depth of said notch;
A pusher movably located in said guide channel and forced by a spring against said engagement member in the door locked state without preventing said engagement member from expelling from said notch upon rotating said inner member;
A dual blocking means for blocking said pusher in the blocking position to prevent said engagement member from expelling from said notch and to engage said inner and intermediate members, thereby allowing the rotation of said intermediate member by means of the door handle for displacing said lock latch and unlocking the door;
Said dual blocking means including two locking bars for entering lateral recesses on said pusher, and one of said blocking bars, designed for preferable use, is provided with an electrical drive controlled by user by means of its turning on, and the other of said blocking bar, designed for alternate use, is provided with a mechanical drive controlled by user by means of the door key;
Said pusher and blocking bars disposed in the door plane.

14. The door locking system of claim 13, wherein said turning on of electrical drive is executed through an electronic digital device by dialing a digital code.
